(19) United States
(12) Patent Application Publication
(10) Pub. No.: US 2009/0150591 A1
(43) Pub. Date: Jun. 11, 2009

(54) VIDEO COMMUNICATION NETWORK-COMPUTER INTERFACE DEVICE

(76) Inventor: Shaowen Song, Waterloo (CA)

Correspondence Address: ANTHONY ASQUITH, 28-461 COLUMBIA STREET WEST, WATERLOO, ON, N2T 2P5, CA

(21) Appl. No.: 12/330,011

(22) Filed: Dec. 8, 2008

Related U.S. Application Data
(60) Provisional application No. 60/996,806, filed on Dec. 6, 2007.

(51) Int. Cl. G06F 13/14; H04L 12/56

(52) U.S. Cl. 710/305; 370/389; 375/240.01

(57) ABSTRACT

The interface device is interposed between a switched-packet network and the bus of a computer. The interface device de-packets and de-compresses HD video data from the network, and places the de-packeted and de-compressed HD video data stream on the computer bus, ready for display. The interface device also compresses and packets HD video data from a video source and transmits the compressed and packetized HD video data to a packet network. The operations involving manipulation of the video data, including the packeting/de-packeting and compressing/de-compressing operations, are done, in the interface device, by hardware. The interface device enables an under-four GHz PC to carry out real-time two-way HD video communications.

It is unlikely that the computing power of a computer, in terms of CPU clock frequency, will increase dramatically in the next several years, much beyond the present levels of under-four Giga-Hertz. In order to increase computing power, designers will increasingly resort to parallel processing (dual-core, quad-core, etc), in personal computers, whereby it can be expected that the resulting cost of the overall CPU will increase almost pro-rata with the number of processors. This situation may be contrasted with the traditional regular reductions in the cost of processing performance, by increasing the clock speed.

On the other hand, internet speeds may be expected to continue to increase. Switched-packet network speeds around 100 Mega-bits per second can now, or in the near future, be expected from a typical high speed internet connection to a PC.

### BACKGROUND

High-Definition (HD) video operates at a screen height of 1080 pixels, and uncompressed HD video typically represents a video data stream in the region of two Giga-bits per second. Assuming substantially-lossless compression at around forty-to-one, a compressed HD video feed requires a bandwidth in the order of fifty or eighty megabits per second. It will thus shortly become perfectly feasible to transmit HD video feeds easily over a high-speed internet connection, and thus to communicate HD video in real time to and from the personal computers of home and office users.

However, the difficulty arises that the computing power of PCs will not be adequate to the immense task of processing HD video data in real time—at least, not without a large increase in the cost of the PC. The problem lies with the tasks of de-packetizing and de-compressing the video data received from the internet (or other network), rapidly enough that the depacketed and decompressed stream can be fed to the display monitor in real time. Bi-directional HD video communication would require even higher computing power.

In order for these tasks to be completed rapidly enough, by traditional software methods, the PC would have to have a CPU of a single processor capable of performing at forty Giga-Hertz or more. So, it is the de-packetization and de-compression of the incoming video data in real time that is, and will continue to be, beyond the computing power of the typical PC.

The restriction applies similarly in reverse, i.e. to the tasks of compressing and packetizing HD video from a local source such as a camera, for preparing that HD video for real-time transmission over the internet.

Thus, the typical PCs that are expected to be the norm for the next several years will not be powerful enough to enable the goal to be reached, of one-way or two-way real-time video communication in HD, over the internet.

### SOME FEATURES OF THE INVENTION

The invention provides a relatively inexpensive network-computer interface device, which can be interposed between a packet-switching network (e.g. the internet) and a PC. The device includes a de-packetization module or unit, herein termed a depacketing unit, and includes a de-compression module or unit. Both of these units are hardware-based.

The expression “hardware-based” is used herein in its normal data-processing sense. Thus, “hardware based” means that the depacketing unit and the decompressing unit of the network-computer interface device (or at least the portions of the units that handle the video data payload) exist physically as an array of logic gates forming a digital logic circuit, and those data manipulation operations are carried out by appropriate routing of the video data payload through appropriate gates. The required manipulation operations upon the video data payload should not be carried out by executable software programs, i.e. by the CPU of a personal computer. (The expression “hard” herein should be understood as short for “hardware-based”.)

The notion of creating a hardware chip implementation of a functional software process is of course very well known. Traditionally, hardware chips are implemented in the form of Application Specific Integrated Circuits, or ASICs. The process required to bring an ASIC up to a condition of marketability has meant that the hardware implementation has been expensive. The greater the complexity of the task that is being committed to hardware, and the greater the variety of the tasks that are to be completed, the more expensive are the tasks of designing, prototyping, testing, de-bugging, etc. It may be regarded that simply adding even a small number of separate tasks together onto a single ASIC chip traditionally, in many cases, has meant that the difficulties and expenses are, not just added, but multiplied.

However, with the advent of such technologies as the field-programmable-gate-array (FPGA) technology, it has recently become easier to create a hardware solution. The designing, prototyping, testing, de-bugging of the hardware solution can all now be done faster, and at a significantly reduced cost. One large benefit of using FPGA and like technologies is that the hard version, when finally (and inexpensively) implemented, can be already in a state of marketability.

In the network-computer interface device as described herein, the required manipulations of the payload video data should be done by hardware. It is recognized that the manipulations that need to be done, in real time, in order to make packetized compressed HD video data ready for display, are really not practical if done by executable software programs and dynamic memory—at least, not with the computing power that can reasonably be expected to exist in upcoming personal computers.

Some hardware solutions to the task of compressing and de-compressing video data are already known. However, even if the compression/decompression task were to be converted to hardware, still the remaining payload-processing tasks would be too demanding for the CPU on a PC. It is recognized that the network-computer interface device should combine the two hardware implementations, i.e. both for compression/de-compression and for packetization/de-packetization. This combination is an important factor in the enablement of internet-communicated real-time HD video on a PC. And, as mentioned, it is relatedly recognized that the advent of FPGA has made the task of creating the hardware for these tasks, and even combining the hardware solutions into a single chip, relatively undemanding and inexpensive.

Again, it is recognized that, given the likely rates of increase in the bandwidth of the internet, the internet itself is (or soon will be) ready for internet-communicated real-time HD video; but unfortunately, given the likely drop-off in the rate of increase of computing power of the PC, that computing power likely will not be adequate to the task of manipulating packetized compressed video data fast enough to enable real-time display of internet-communicated HD video on a PC, at least not in an inexpensive way.

It is recognized that this problem can be alleviated by providing hardware solutions to, preferably, all the operations that involve the manipulation of the payload video data. On the other hand, it is recognized that it is not required that some of the control tasks and operations be necessarily hardware-based. That is to say, such tasks, can, if desired, be left to software (i.e. to executable programs and dynamic memory) on the PC.

Conventionally, compressed packeted video data received from a packet-switching network is dealt with, in a PC, in the following manner. First, the video data is de-packetized. This might be done by means of an Ethernet card in combination with networking software running on the computer CPU (e.g. a TCP/IP stack), which strips off the header and overhead data from the packets, depacketizes the payload data stream, and delivers the video data stream, still compressed, to the computer's data bus, or to be stored into the computer main memory.

Then, the computer CPU uses appropriate software which enables the processor to decompress the video data stream. The computer processor also uses appropriate software which enables the processor to deliver the decompressed video data stream to the monitor-driver in a form whereby the stream can be displayed on the monitor.

By the use of the new network-computer interface device, as described herein, the packeted video data received from a network now is dealt with, by contrast, in the following manner. Again, the incoming packetized video data stream is de-packetized in a depacketing unit. The depacketing unit is hardware-based, i.e. the structure of the unit includes an array of digital logic gates, through which the payload video data is passed.

The now de-packetized video stream passes to a decompressing unit. Again, the decompressing unit is hardware-based: i.e., in the decompressing unit, the stream of payload video data passes through an array of digital logic gates.

The now-decompressed video stream passes into a bus interface module, which preferably also is hardware-based. From there, the video stream can be fed into the data bus of the computer. The computer can route the uncompressed video stream onto the computer's monitor, and the user can watch the video. Thus, by the use of the interface device, the video data has been processed through from the network to the monitor basically without the need for the computer's processor to execute any software operations on the payload video data. (It is mentioned again that it is not, for present purposes, essential that manipulations of the non-payload (i.e. overhead) components of the video data (and the video data packets) be done by hardware. It is recognized that these tasks are well within the capabilities of the CPU processor of a typical PC.)

The network-computer interface device is interposed between the network and the computer bus. Thus positioned, the interface device receives the compressed video data from the network in packetized form, and transforms that data into a de-compressed stream, which is then fed directly into the computer's data bus. Thus, the computer's CPU is no longer required to perform the task of executing software programs to process the compressed video data stream. These processing tasks have been off-loaded to the interface device. The CPU remains free to conduct other high-level operations—which can only improve overall performance of the system.

It has been described that the HD video data received from the packet-switching network, having been de-packetized and de-compressed, is fed to the data bus of the PC as a decompressed video data stream. It is recognized that the PC computer is not, as such, essential to the task of displaying the video stream. The uncompressed HD video data stream can, instead, be routed through a dedicated interface unit that prepares the uncompressed video data stream for display on a screen (e.g. a TV screen) directly, i.e. without going through a computer. Similarly, in the case of video originated by the user, again the raw video output from, say, a camera could be passed to the hardware-based interface device as described herein, for transmission to the network, via a dedicated interface unit, without passing through a PC computer.

As a general rule, however, a user-operable PC does provides a simple vehicle whereby the user can control such mundane functions as opening the internet connection, and selecting the correct video feed from those available on the network.

### LIST OF DRAWINGS

In the accompanying drawings:—

FIG. 1 is a block diagram of a network-computer interface device, configured to receive HD video data from a packet-switching network, and to present a de-packetized and de-compressed data stream for display.

FIG. 2 is a similar diagram, but now the device is configured to receive an uncompressed unpacketized video data stream, and to place compressed and packetized video data onto the network for transmission.

FIG. 3 is a similar diagram, but now the device is configured to enable both packetization and de-packetization, and to enable both compression and de-compression.

FIG. 4 is a diagram of some elements of the de-packeting unit of FIG. 1.

FIG. 5 is a diagram shows the positioning of the network-computer interface device, in relation to a computer, in more detail.

The scope of the patent protection sought herein is defined by the accompanying claims. The features and operations shown in the drawings and described below are examples.

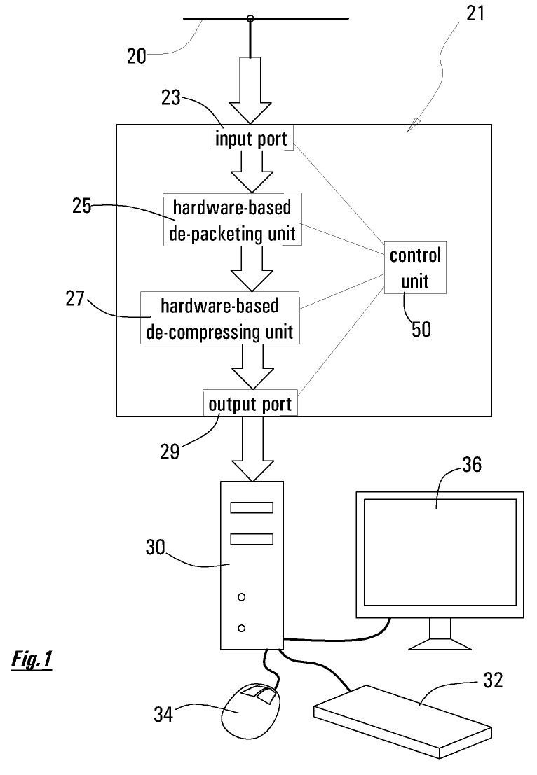

In FIG. 1, packetized, compressed, video data from the internet 20 is routed into the network-computer interface device 21 via input port 23. From there, the video data is de-packetized by means of a hardware-based de-packeting unit 25. The de-packeting unit 25 also includes functions of network protocols for communicating with the network for data communications. The resulting video data stream is then de-compressed by means of the hardware-based de-compressing unit 27 (being a digital signal processor, DSP). The de-compressed video data stream then passes through output port 29, and into the data bus of a conventional computer (PC) 30, having a keyboard 32, mouse 34, and video display monitor 36.

The output port 29 should be understood to include, or to consist of, a bus interface unit, which handles the communications between the network-computer interface device and the PC. Insofar as the bus interface unit involves processing of the payload video data, it too should be hardware-based.

The function of the network-computer interface device 21 is to prepare the de-packetized and de-compressed video data stream for presentation to the PC data bus. The presence of the network-computer interface device 21, which interfaces between the network 20 and the data bus of the PC 30, means that all internet traffic, not just HD video, passes through the device. Thus the PC itself is freed from the need to use computing power to process the internet data, which releases the computing power for other tasks. Alternatively, the network-computer interface device 21 can be configured to allow non-video packets to go through the traditional network port, e.g. the Ethernet port.

In FIG. 1, the network-computer interface device 21 is physically external to the PC. When external, the device can be in its own box, with its own power supply, etc. In an alternative, the interface device 21 is physically internal to the computer, the interface device then taking the form of, for example, a PCI or PCI-express card. The connections from the interface device to the network and to the PC can be wired or wireless.

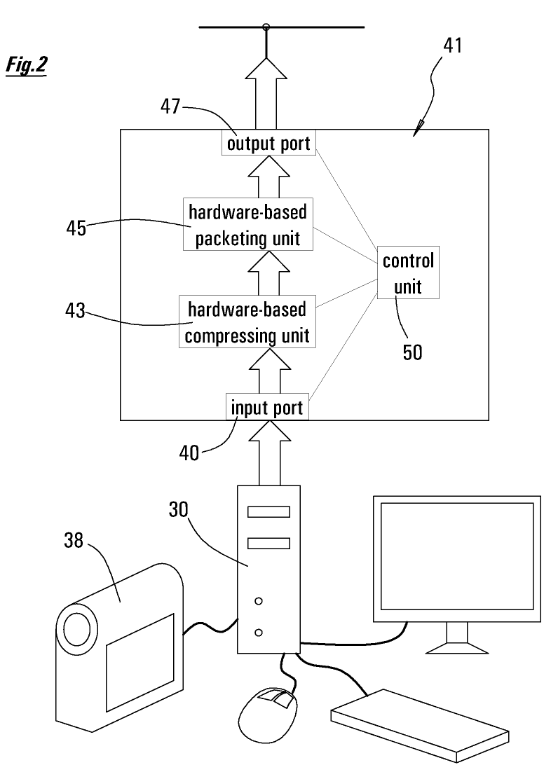

In FIG. 2, an uncompressed video data stream from camera 38 is routed by the PC 30 into input port 40 of the network-computer interface device 41. The video stream is compressed by compressing unit 43, and packetized by packeting unit 45. The compressed packetized video data is placed on the network via output port 47.

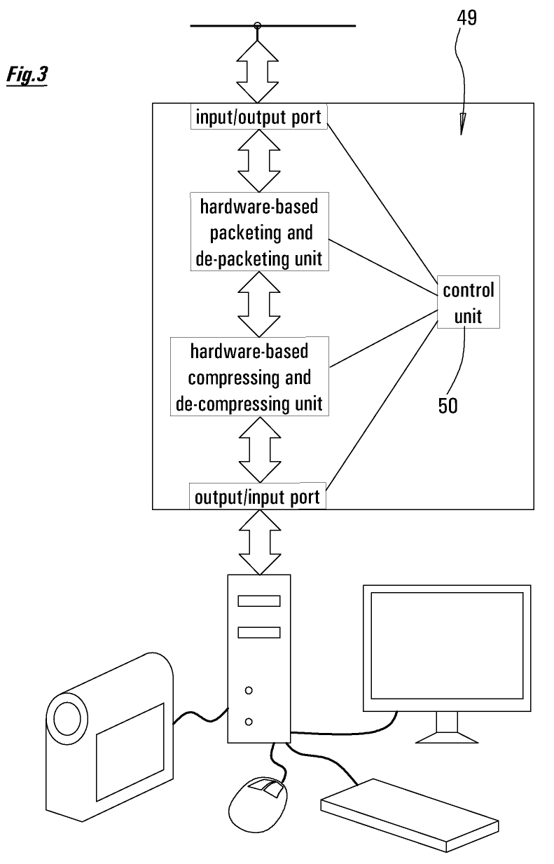

In FIG. 3, the network-computer interface device 49 is capable of both packetizing and de-packetizing, and is capable of both compressing and de-compressing, whereby real-time back and forth video communication can take place.

Because the payload video data is operated upon only by the hardware-based equipment in the two-way network-computer interface device 49, the two-way video communication, though done in real time, can be done at High Definition levels.

In the network-computer interface devices as shown in FIGS. 1-3, the control unit 50 coordinates the overall activities of the hardware components, and handles additional quality-control functions that are not included in the other components of the network-computer interface device. Such co-ordination, insofar as it is not dealing with the actual payload video data, is not particularly demanding of computing power, and can be done by appropriate software within the interface device itself, or it can be done by the host computer.

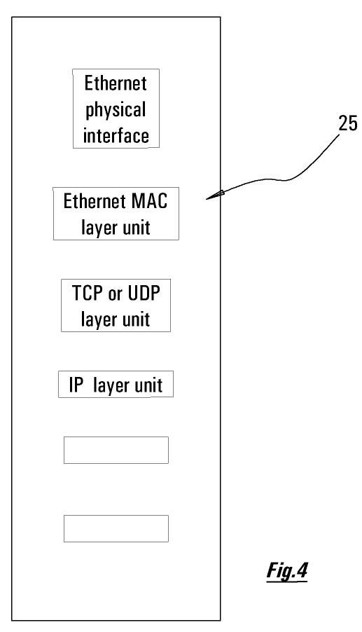

FIG. 4 shows some of the components of the de-packeting unit 25 of FIG. 1 In addition to the components indicated, the unit 25 also integrates additional elements of network handling and real-time data quality controls into the various layers. These elements include real-time data buffering and data management, which are not specified in the TCP/IP, UDP, and Ethernet protocols. Bandwidth managements, including bandwidth reservation, monitoring, and utilization, are also integrated into the unit 25. The blank boxes in FIG. 4 indicate the capability of implementing other network protocols (apart from IP, TCP, USP, Ethernet) such as SONET and DSL.

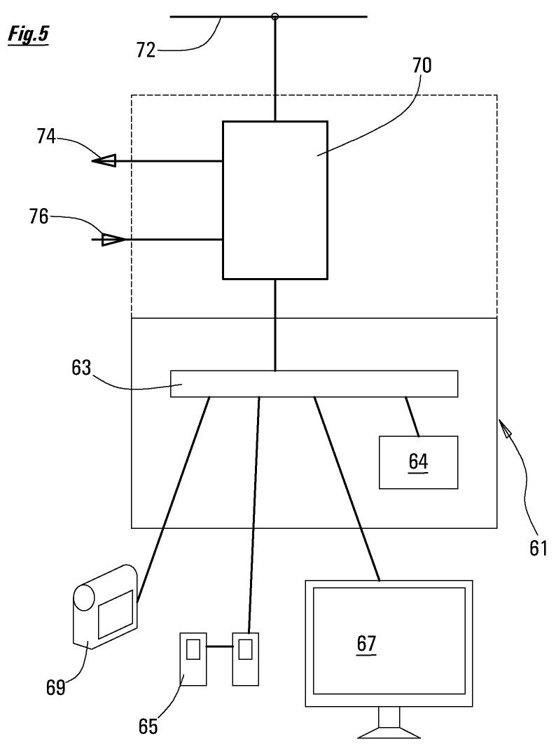

FIG. 5 shows a PC computer 61, having a data bus 63. Connected to the data bus are the CPU 64 of the PC, speakers 65 and a screen 67 for displaying video signals, and a camera 69. Also connected to the data bus 63 is a two-way network-computer interface device 70 of the kind shown in FIG. 3. The interface device 70 is connected between the internet or other packet-switching network 72 and the data bus 63 of the PC 61. Also included in the interface device 70 is an output 74 which goes directly to e.g. a TV, and an input 76 which enables video from e.g. a camera to be fed directly into the interface device 70. The dashed line in FIG. 5 indicates that the network-computer interface device 70 can be located inside or outside the PC 61.

Preferably, all the functions in the interface device 70 that can be done with hardware, are done with hardware—and preferably all the functions are integrated on a single monolithic chip.

1. A network-computer interface device, for transforming received packetized and compressed video data into an uncompressed video data stream for video display, wherein:
the device includes a depacketing unit and a decompressing unit;
the device includes an input port, through which the device can receive packets of compressed video data from a packet-switching network;
the depacketing unit is hardware-based;
the hard depacketing unit is so structured that, having received packets of compressed video data, the depacketing unit implements a protocol that transforms the packetized compressed video data into a de-packetized compressed video data stream;
the decompressing unit is hardware-based;
the hard decompressing unit is so structured that, having received the de-packetized compressed video data stream, the decompressing unit implements a protocol that transforms the compressed video data stream into an uncompressed video data stream;
the device includes an output port, through which the device can transmit the uncompressed video data stream to a video display unit.

2. A network-computer interface device, for transforming a received uncompressed video data stream from a video source, such as a camera, into packetized compressed video data, for transmission to a packet-switching network, wherein:
the device includes a packeting unit and a compressing unit;
the device includes an input port, through which the device can receive the uncompressed video data stream;
the compressing unit is hardware-based;
the hard compressing unit is so structured that, having received the uncompressed video data stream, the compressing unit implements a protocol that transforms the uncompressed video data stream into a compressed video data stream;
the packeting unit is hardware-based;
the hard packeting unit is so structured that, having received the compressed video data stream, the packeting unit implements a protocol that transforms the compressed video data stream into packetized compressed video data;
the device includes an output port, through which the device can transmit packets of compressed video data to a packet-switching network.

3. A network-computer interface device, wherein:
the device is for transforming packeted compressed video data received from a packet-switching network into an uncompressed video data stream for video display, and for transforming a received uncompressed video data stream from a video source, such as a camera, into packetized compressed video data for transmission to a packet-switching network, wherein
the device includes a packeting/depacketing unit and a compressing/decompressing unit;
the device includes an input/output port, through which the device can receive packets of compressed video data from the packet-switching network, and through which the device can transmit packetized compressed video data to the packet-switching network;
the packeting/depacketing unit is hardware-based;
the hard packeting/depacketing unit is so structured that, having received packets of compressed video data, the hard packeting/depacketing unit implements a protocol that transforms the packetized compressed video data into a de-packetized compressed video data stream;
the hard packeting/depacketing unit is so structured that, having received an unpacketized compressed video data stream, the hard packeting/depacketing unit implements a protocol that transforms the unpacketized compressed video data stream into packets of compressed video data;
the compressing/decompressing unit is hardware-based;
the hard compressing/decompressing unit is so structured that, having received the de-packetized compressed video data stream, the hard compressing/decompressing unit implements a protocol that transforms the compressed video data stream into an uncompressed video data stream;
the hard compressing/decompressing unit is so structured that, having received the uncompressed video data stream, the hard compressing/decompressing unit implements a protocol that transforms the uncompressed video data stream into a compressed video data stream;
the device includes an output/input port, through which the device can transmit the uncompressed video data stream to a video display unit, and through which the device can receive the uncompressed video data stream from the video source.

4. As in claim 1, wherein:
the hard depacketing unit is so structured as to be capable of de-packeting the compressed video data into a de-packetized compressed video data stream; and
the hard decompressing unit is so structured as to be capable of de-compressing the compressed video data stream into an uncompressed video data stream;
in real time.

5. As in claim 1, wherein the network-computer interface device is structured and configured for operation external to a host computer, and for communication therewith through a wired or wireless connection to the computer for the transmission of video data therebetween.

6. As in claim 1, wherein the network-computer interface device is structured and configured for operation internally within a host computer, being configured for physical connection to a data bus thereof, for example by being mounted on a PCI card.

7. As in claim 1, wherein the video display unit is a TV, and the output port of the network-computer interface device connects directly to the TV, without going through a computer.

8. The network-computer interface device of claim 1 in combination with a computer, wherein the computer has sufficient computing power to display a de-compressed HD-format video data stream in real time.

9. The network-computer interface device of claim 1, in use to receive packetized and compressed video data from the packet-switching network, to de-packet and de-compress the said data, and to deliver a corresponding de-packetized and de-compressed video data stream in real time to the video display unit.

10. As in claim 9, wherein the said video data stream is of High-Definition (HD) format.

11. As in claim 2, wherein:
the hard compressing unit is so structured as to be capable of compressing the uncompressed video data stream into a compressed video data stream; and
the hard packeting unit is so structured as to be capable of packetizing the compressed video data stream into packetized compressed video data;
in real time.

12. As in claim 2, wherein the network-computer interface device is structured and configured for operation external to a host computer, and for communication therewith through a wired or wireless connection to the computer for the transmission of video data therebetween.

13. As in claim 2, wherein the network-computer interface device is structured and configured for operation internally within a host computer, being configured for physical connection to a data bus thereof, for example by being mounted on a PCI card.

14. As in claim 2, wherein the video source is a camera, and the camera connects directly to the input port of the network-computer interface device, without going through a computer.

15. The network-computer interface device of claim 2, in use to receive uncompressed video data from the video source, to compress and packetize the said data stream, and to deliver corresponding compressed and packetized video data in real time to the packet-switching network.

16. As in claim 15, wherein the said video data stream is in High-Definition (HD) format.

17. As in claim 3, wherein:
the hard depacketing unit is so structured as to be capable of de-packeting the compressed video data into a de-packetized compressed video data stream; and
the hard decompressing unit is so structured as to be capable of de-compressing the compressed video data stream into an uncompressed video data stream; and
the hard compressing unit is so structured as to be capable of compressing the uncompressed video data stream into a compressed video data stream; and
the hard packeting unit is so structured as to be capable of packetizing the compressed video data stream into packetized compressed video data;
in real time.

18. As in claim 3, wherein the network-computer interface device is structured and configured for operation external to a host computer, and for communication therewith through a wired or wireless connection to the computer for the transmission of video data therebetween.

19. As in claim 3, wherein the network-computer interface device is structured and configured for operation internally within a host computer, being configured for physical connection to a data bus thereof, for example by being mounted on a PCI card.

20. As in claim 3, wherein the video source is a camera, and the camera connects directly to the input port of the network-computer interface device, without going through a computer.

21. The network-computer interface device of claim 3, in combination with a computer, wherein the computer has sufficient computing power to display a de-compressed HD-format video data stream in real time.

22. The network-computer interface device of claim 3, in use to receive uncompressed video data from the video source, to compress and packetize the said data stream, and to deliver corresponding compressed and packetized video data in real time to the packet-switching network; and
in use to receive packetized and compressed video data from the packet-switching network, to de-packet and de-compress the said data, and to deliver a corresponding de-packetized and de-compressed video data stream in real time to the video display unit.

23. As in claim 22, wherein the said video data stream is of High-Definition (HD) format.
